(19) United States
(12) Patent Application Publication
(10) Pub. No.: US 2017/0283605 A1
(43) Pub. Date: Oct. 5, 2017

(54) LIQUID, SEMI-LIQUID, AND SOLID THERMAL INSULATOR AND METHODS FOR MANUFACTURING SAME

(71) Applicant: Angry Troll Laboratory, LLC, Ft. Lauderdale, FL (US)

(72) Inventor: Nelson Emir Cepeda Perez, Fort Lauderdale, FL (US)

(21) Appl. No.: 15/473,048

(22) Filed: Mar. 29, 2017

Related U.S. Application Data
(60) Provisional application No. 62/314,456, filed on Mar. 29, 2016.

(51) Int. Cl. C08L 33/26; C08L 33/10; C09K 21/14

(52) U.S. Cl. CPC C08L 33/26; C09K 21/14; C08L 33/10; C08L 2205/02; C08L 2201/02

(57) ABSTRACT

A thermal insulator composition and methods of manufacturing made from an admixture of a molding compound, a fire suppressant, and a bonding agent. Water can be added to the admixture to develop the insulator into different phases such as liquid and semi-liquid. The molding compound may be a co-polymer such as an acrylate, polyethylmethacrylate, benzoyl peroxide, titanium dioxide, and one or more iron oxides. The fire suppressant may be an aqueous acrylic acid and potassium co-polymer combination, cross-linked modified polyacrylamides/potassium acrylate or polyacrylamides/sodium acrylate. The bonding agent may be a composition of ethyl methacrylate, hydroxyproptyl methacrylate, clycerol dimethacrylate, triethylene glycol, dimethacrylate, dimethyltolyamine, benzophenone-3, and hydroquinone.

This application claims the benefit of U.S. Provisional Application Ser. No. 62/314,456 date Mar. 29, 2016.

### BACKGROUND OF THE INVENTION

This invention is generally related to thermal insulators and more specifically to an advanced high usage performance liquid, semi-liquid, and/or solid thermal insulator and methods of manufacturing same.

Thermal insulators have wide application across a vast number of industries including automotive, marine, general industrial, general manufacturing, and electronics. The most important aspects when considering a thermal insulator is thermal resistance in relation to the weight, surface area, and/or volume of the insulator. It is often important to select a thermal insulator that has the highest resistance to heat transfer for the allotted space. The relative phase and format of the thermal insulator can be particularly important as well as certain applications will require various combinations of liquid, semi-liquid, and solid thermal insulators.

### DETAILED DESCRIPTION

The present invention relates to a thermal insulator composition and methods of manufacturing same. In some embodiments, the thermal insulator composition comprises an admixture of a molding compound, a fire suppressant, and a bonding agent. In some embodiments, water is added to the admixture to develop the insulator into differing phases and states such as liquid and semi-liquid.

In some embodiments, the molding compound comprises a composition of a co-polymer such as an acrylate, polyethylmethacrylate, benzoyl peroxide, titanium dioxide, and one or more iron oxides.

The fire suppressant can be any known or conventional fire suppressant, including biodegradable, super absorbent, aqueous based polymers. Examples of these polymers are an aqueous acrylic acid and potassium co-polymer combination, cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids. Examples of known fire suppressants include without limitation, those marketed under the brand name of FIREICE, CHEMDAL AQUA SHIELD, BARRICADE FIRE GEL, THERMO-GEL, WILDFIRE AFG FIREWALL, BIOCENTRAL BLAZETAMMER and PHOS-CHEK INSUL-8. In some embodiments, the fire suppressant composition comprises one or more fire suppressant compounds. In other embodiments, the fire suppressant composition comprises one or more common components of fire suppressant formulations, such as: fire suppressant salts, known or conventional fire suppressants, corrosion inhibitors, spoilage inhibitors, foaming agents, non-foaming agents, flow conditioners, stability additives, thickening agents, pigments, or the like.

In some embodiments, the fire suppressant comprises penta-bromodiphenyl ether, octa-bromodiphenyl ether, deca-bromodiphenyl ether, short-chain chlorinated paraffins (SCCPs), medium-chain chlorinated paraffins (MCCPs), hexabromocyclododecane (HBCD), tetrabromobisphenol A (TBBPA), tetrabromobisphenol A ether, pentabromotoluene, dibromopropyl-2,4,6-tribromophenyl ether, tetrabromobisphenol A, bis(2,3-dibromopropyl ether), tris(tribromophenoxy)triazine, tris(2-chloroethyl)phosphate (TCEP), tris(2-chloro-1-methylethyl)phosphate (TCPP or TMCP), tris(1,2-dichloropropyl)phosphate (TDCP), 2,2-bis(chloromethyl)-trimethylene bis(bis(2-chloroethyl)phosphate), melamine cyanurate, antimony trioxide Sb2O3 (ATO), boric acid, ammonium polyphosphate (APP), aluminum ammonium polyphosphate, aluminum hydroxide, magnesium hydroxide red phosphorous, 1,2-bis(tribromophenoxy)ethane, 2,4,6-tribromophenyl glycidyl ether, tetrabromo phthalic anhydride, 1,2-bis(tetrabromo phthalimide) ethane, tetrabromo dimethyl phthalate, tetrabromo disodium phthalate, decabromodiphenyl ether, tetradecabromodi(phenoxyl)benzene, 1,2-bis(pentabromophenyl)ethane, bromo-trimethyl-phenyl-hydroindene, pentabromobenzyl acrylate, pentabromobenzyl bromide, hexabromobenzene, pentabromotoluene, 2,4,6-tribromophenyl maleimide, hexabromo cyclododecane, N,N′-1,2-bis(dibromonorbornyl dicarbimide) ethane, pentabromochloro-cyclohexane, tri(2,3-dibromopropyl)isocyanurate, bromo-styrene copolymer, tetrabromobisphenol A-carbonate oligomer, polypentabromobenzyl acrylate, polydibromophenylene ether; chlorinated flame retardants such as dechlorane plus, HET anhydride (chlorendic anhydride), perchloro pentacyclodecane, tetrachloro bisphenol A, tetrachlorophthalic anhydride, hexachlorobenzene, chlorinated polypropylene, chlorinated polyvinyl chloride, vinyl chloride-vinylidene chloride copolymer, chlorinated polyether, hexachloroethane; organic phosphorus flame retardants such as 1-oxo-4-hydroxymethyl-2,6,7-trioxa-1-phosphabicyclo[2,2,2]octane, 2,2-dimethyl-1,3-propanediol-di(neopentyl glycol)diphosphate, 9, 10-dihydro-9-oxa-10-phosphaphenanthrene-10 oxide, bis(4-carboxyphenyl)-phenyl phosphine oxide, bis(4-hydroxyphenyl)-phenyl phosphine oxide, phenyl(diphenyl sulfone) phosphate oligomer; phosphorus-halogenated flame retardants such as tris(2,2-di(bromomethyl)-3-bromopropyl)phosphate, tris(dibromophenyl)phosphate, bis(tribromophenoxy)-2,4,8,10-tetraoxa-3,9-diphosphaspiro[5,5]-3,9-di-oxo-undecane, bis(pentabromophenoxy)-2,4,8,10-tetraoxa-3,9-diphosphaspiro[5,5]-3,9-dioxo-undecane, oxo-4-tribromophenoxycarbonyl-2,6,7-trioxa-1-phosphabicyclo[2,2,2]octane, p-phenylene-tetrakis(2,4,6-tribromophenyl)-diphosphate, 2,2-di(chloromethyl)-1,3-propanediol-di(neopentyl glycol)diphosphate, 2,9-di(tribromo-neopentyloxy)-2,4,8,10-tetraoxa-3,9-diphosphaspiro[5,5]-3,9-dioxo-undecane; nitrogen-based flame retardants or phosphorus-nitrogen-based flame retardants such as melamine, melamine cyanurate, melamine orthophosphate, dimelamine orthophosphate, melamine polyphosphate, melamine borate, melamine octamolybdate, cyanuric acid, tris(hydroxyethyl)isocyanurate, 2,4-diamino-6-(3,3,3-trichloro-propyl)-1,3,5-triazine, 2,4-di(N-hydroxymethyl-amino)-6-(3,3,3-trichloro-propyl-1,3,5-triazine), diguanidine hydrophosphate, guanidine dihydrogen phosphate, guanidine carbonate, guanidine sulfamate, urea, urea dihydrogen phosphate, dicyandiamide, melamine bis(2,6,7-trioxa-phospha-bicyclo[2.2.2]octane-1-oxo-4-methyl)-hydroxy-phosphate, 3,9-dihydroxy-3,9-dioxo-2,4,8,10-tetraoxa-3,9-diphosphaspiro[5.5]undecane-3,9-dimelamine, 1,2-di(2-oxo-5,5-dimethyl-1,3-dioxa-2-phosphacyclohexyl-2-amino) ethane, N,N′-bis(2-oxo-5,5-dimethyl-1,3-dioxa-2-phosphacyclohexyl)-2,2′-m-phenylenediamine, tri(2-oxo-5,5-dimethyl-1,3-dioxa-2-phosphacyclohexyl-2-methyl)amine, hexachlorocyclotriphosphazene; and inorganic flame retardants such as red phosphorus, ammonium polyphosphate, diammonium hydrophosphate, ammonium dihydrogen phosphate, zinc phosphate, aluminum phosphate, boron phosphate, antimony trioxide, aluminum hydroxide, magnesium hydroxide, hydromagnesite, alkaline aluminum oxalate, zinc borate, barium metaborate, zinc oxide, zinc sulfide, zinc sulfate heptahydrate, aluminum borate whisker, ammonium octamolybdate, ammonium heptamolybdate, zinc stannate, stannous oxide, stannic oxide, ferrocenc, ferric acetone, ferric oxide, ferro-ferric oxide, ammonium bromide, sodium tungstate, potassium hexafluorotitanate, potassium hexafluorozirconate, titanium dioxide, calcium carbonate, barium sulfate, sodium bicarbonate, potassium bicarbonate, cobalt carbonate, zinc carbonate, basic zinc carbonate, heavy magnesium carbonate, basic magnesium carbonate, manganese carbonate, ferrous carbonate, strontium carbonate, sodium potassium carbonate hexahydrate, magnesium carbonate, calcium carbonate, dolomite, basic copper carbonate, zirconium carbonate, beryllium carbonate, sodium sesquicarbonate, cerium carbonate, lanthanum carbonate, guanidine carbonate, lithium carbonate, scandium carbonate, vanadium carbonate, chromium carbonate, nickel carbonate, yttrium carbonate, silver carbonate, praseodymium carbonate, neodymium carbonate, samarium carbonate, europium carbonate, gadolinium carbonate, terbium carbonate, dysprosium carbonate, holmium carbonate, erbium carbonate, thulium carbonate, ytterbium carbonate, lutetium carbonate, aluminium diacetate, calcium acetate, sodium bitartrate, sodium acetate, potassium acetate, zinc acetate, strontium acetate, nickel acetate, copper acetate, sodium oxalate, potassium oxalate, ammonium oxalate, nickel oxalate, manganese oxalate dihydrate, iron nitride, sodium nitrate, magnesium nitrate, potassium nitrate, zirconium nitrate, calcium dihydrogen phosphate, sodium dihydrogen phosphate, sodium dihydrogen phosphate dihydrate, potassium dihydrogen phosphate, aluminum dihydrogen phosphate, ammonium dihydrogen phosphate, zinc dihydrogen phosphate, manganese dihydrogen phosphate, magnesium dihydrogen phosphate, disodium hydrogen phosphate, diammonium hydrogen phosphate, calcium hydrogen phosphate, magnesium hydrogen phosphate, ammonium phosphate, magnesium ammonium phosphate, ammonium polyphosphate, potassium metaphosphate, potassium tripolyphosphate, sodium trimetaphosphate, ammonium hypophosphite, ammonium dihydrogen phosphite, manganese phosphate, dizinc hydrogen phosphate, dimanganese hydrogen phosphate, guanidine phosphate, melamine phosphate, urea phosphate, strontium dimetaborate hydrogen phosphate, boric acid, ammonium pentaborate, potassium tetraborate octahydrate, magnesium metaborate octahydrate, ammonium tetraborate tetrahydrate, strontium metaborate, strontium tetraborate, strontium tetraborate tetrahydrate, sodium tetraborate decahydrate, manganese borate, zinc borate, ammonium fluoroborate, ammonium ferrous sulfate, aluminum sulfate, potassium aluminum sulfate, ammonium aluminum sulfate, ammonium sulfate, magnesium hydrogen sulfate, aluminum hydroxide, magnesium hydroxide, iron hydroxide, cobalt hydroxide, bismuth hydroxide, strontium hydroxide, cerium hydroxide, lanthanum hydroxide, molybdenum hydroxide, ammonium molybdate, zinc stannate, magnesium trisilicate, telluric acid, manganese tungstate, manganite, cobaltocene, 5-aminotetrazole, guanidine nitrate, azobisformamide, nylon powder, oxamide, biuret, pentaerythritol, decabromodiphenyl ether, tetrabromo-phthalic anhydride, dibromoneopentyl glycol, potassium citrate, sodium citrate, manganese citrate, magnesium citrate, copper citrate, ammonium citrate, nitroguanidine.

In some embodiments, the bonding agent of the thermal insulator comprises a composition of ethyl methacrylate, hydroxyproptyl methacrylate, clycerol dimethacrylate, triethylene glycol, dimethacrylate, dimethyltolyamine, benzophenone-3, and hydroquinone.

The admixture can be manufactured in accordance with various methods and combining steps. In one embodiment, the molding compound and the fire suppressant are combined to form “part 1” of the admixture. “Part 1” is then combined with the bonding agent and mixed until an even consistency is achieved. At this point, a small amount of water can be added to the admixture and the combination will become exothermic, causing a slight elevation in temperature of approximately 10-12 degrees Fahrenheit.

When the temperature elevation is detected, the composition is begun to cure. At this point, the physical molding or application of the composition should take place so that it can be properly applied to a desired substrate before cooling. To that end, the term “substrate” is understood to be any object or material that desired to be thermally insulated by way of the thermal insulator composition of this invention. In this embodiment, the final state of the thermal insulator composition will be a solid. In some embodiments, the final mix should be allowed to fully cure for at least 3 hours, depending on the thickness of application.

The phase and physical properties of the thermal insulator composition can be varied by varying the relative amounts of the components thereof. For example, if a more flexible semi-solid or gel-like composition is desired, then additional water and fire suppressant should be added. If a stiffer solid is desired, then additional molding compound and fire suppressant should be added during the curing process. If a liquid form is desired, the molding compound should be omitted.

In one particular embodiment, to form an effective amount of the thermal insulator composition approximating the size of a standard bar of soap, the composition is manufactured by providing 2 tablespoons of the part 1, i.e. the molding compound plus fire suppressant, with 1 ounce of the bonding agent and the mixing evenly. Two ounces of water are added to the admixture and mixing continues until the exothermic reaction is detected. Then the composition is cured to its final state for at least 3 hours.

The present invention results in a thermal insulator that is moldable, eco-friendly, and biodegradable. The thermal resistance properties are exceptional, demonstrating resistance to heat of at least 1200 degrees Fahrenheit without heat transfer of any kind, yet having minimal or no degradation of the composition. This is caused by the chemical reaction of the ingredients which results in an exceptional cross-link that resists heat transfer while maintaining its structural integrity. In some embodiments, the thermal insulator composition comprises a polyethyl methacrylate (PEMA) composition having an especially strong cross-linked characteristic that provides extreme thermal resistance.

Due to the fact that the composition can be produced in various phases, states, and consistencies, it is extremely versatile with respect to the variety of applications for which it can be used. Some examples of applications include usage as a general heat shield for conductive materials in heavy machinery including internal combustion engines or elsewhere a thermal insulation is desired. It can also have applications in consumer products such as cookware and use on handles and other components where high factors of safety are required with respect to thermal resistance. Again, due to the versatility of the final product, the applications are virtually limitless.

While specific embodiments have been described in detail in the foregoing detailed description and illustrated in the accompanying drawings, those with ordinary skill in the art will appreciate that various modifications and alternatives to those details could be developed in light of the overall teachings of the disclosures. Accordingly, the particular arrangements disclosed are meant to be illustrative only and not limiting of the invention, which is to be given the full breadth of the appended claims, and any and all equivalents thereof.

What is claimed is:

1. A thermal insulator composition, comprising a molding compound, an effective amount of a fire suppressant, and a bonding agent.

2. The thermal insulator composition of claim 1, wherein the molding compound comprises a composition of a co-polymer such as an acrylate, polyethylmethacrylate, benzoyl peroxide, titanium dioxide, and one or more iron oxides.

3. The thermal insulator composition of claim 1, wherein the fire suppressant comprises an aqueous acrylic acid and potassium co-polymer combination, cross-linked modified polyacrylamides/potassium acrylate or polyacrylamides/sodium acrylate.

4. The thermal insulator composition of claim 1, wherein the bonding agent bonding comprises a composition of ethyl methacrylate, hydroxyproptyl methacrylate, clycerol dimethacrylate, triethylene glycol, dimethacrylate, dimethyltolyamine, benzophenone-3, and hydroquinone.

5. The thermal insulator composition of claim 1, further comprising water.

6. A method of manufacturing a thermal insulator composition, comprising:
combining a molding compound with an effective amount of a fire suppressant to form a first intermediate composition;
combining said first intermediate composition with a bonding agent; and
curing said combination of said first intermediate composition and said bonding agent.

7. The method of claim 6, further comprising the step of adding water prior to said curing step.

8. The method of claim 6, wherein the molding compound comprises a composition of a co-polymer such as an acrylate, polyethylmethacrylate, benzoyl peroxide, titanium dioxide, and one or more iron oxides.

9. The method of claim 6, wherein the fire suppressant comprises an aqueous acrylic acid and potassium co-polymer combination, cross-linked modified polyacrylamides/potassium acrylate or polyacrylamides/sodium acrylate.

10. The method of claim 6, wherein the bonding agent bonding comprises a composition of ethyl methacrylate, hydroxyproptyl methacrylate, clycerol dimethacrylate, triethylene glycol, dimethacrylate, dimethyltolyamine, benzophenone-3, and hydroquinone.
